(19) United States
(12) Patent Application Publication
(10) Pub. No.: US 2007/0299705 A1
(43) Pub. Date: Dec. 27, 2007

(54) METHOD AND APPARATUS FOR OBSERVATION MODEL VALIDATION

(76) Inventors: Shyh-Kwei Chen, Chappaqua, NY (US); Joachim H. Frank, Greenwich, CT (US); Jana Koehler, Oberrieden (CH); Hui Lei, Scarsdale, NY (US); Michael Sebastian Wahler, Zurich (CH)

Correspondence Address: LAW OFFICE OF IDO TUCHMAN (YOR), 82-70 BEVERLY ROAD, KEW GARDENS, NY, 11415, US

(21) Appl. No.: 11/741,385

(22) Filed: Apr. 27, 2007

(30) Foreign Application Priority Data
Apr. 27, 2006 (EP) 06113199.1

(51) Int. Cl. G06F 9/44

(52) U.S. Cl. 705/7

(57) ABSTRACT

A method and apparatus are provided for validating an observation model. The apparatus includes an observation model separator configured to receive the observation model and identify a constraint applicable to the observation model. The apparatus further includes a validation algorithm processor configured to classify the applicable constraint and validate the observation model dependent on the constraint category of the applicable constraint.

### TECHNICAL FIELD

The present invention relates to the field of monitoring systems, and particularly relates to a method and apparatus for observation model validation.

### BACKGROUND OF THE INVENTION

Businesses need to have real-time, specific data about their own operations. They also need to respond to certain events as they occur in real-time. To address these needs, business monitoring engines evolved. Business monitoring engines are computer-based systems which monitor real-world systems pertaining to a given business. The larger a business is, the less able any one employee of the business is to be aware of the state of the business as a whole. Thus, computerization of the business monitoring process may be used because computers can process the massive amounts of data required to monitor even the largest business in real-time. Computers can determine when a situation exists which requires an action and can notify the appropriate human or technological actor.

A datum tracked by a business monitoring engine is referred to as a business metric. One type of business metric is the tracking data of a single instance of a business process (for example, start and end of individual steps, duration of an activity, human actors involved, etc.). Another type of business metric is the amount of revenue from the sale of a product, or a category of products. The numeric amount of revenue received would be a business metric. Business metrics from multiple workflow instances can be aggregated into business process statistics, sales statistics by product or by country, etc. which would be higher-level business metrics. For example, a business may wish to model the amount of revenue earned in an entire country in one day. This statistic would be computed by adding the revenues from each individual sale in that country on that day. The resulting sum would be another business metric. Such aggregation may be repeated at an arbitrary number of levels. At a high level, these aggregates are sometimes known as “key performance indicators” and may include revenue, cost, and average, minimum and/or maximum response time, and such high-level metrics are deemed significant indicators of a business's performance.

Terminology used in the field of business monitoring engines may include the following;

a ‘business process model’ describes the workflow of a business, and a ‘workflow instance’ implements the business process model;

a ‘workflow model’ defines one or more execution paths within a business process model;

an ‘observation model’ describes the monitoring of the business process model in a graphical way. Within an observation model, one or more business metrics are shown to be operated on by a so-called ‘map’ along a graphically illustrated ‘execution path’. An observation model can be considered as a description of a workflow ie. an operational aspect of a work procedure. An ‘observation model element’ may be either a concept or an association between concepts, where a concept is a business metric or a map.

a ‘business metric’ is a storage of data and can be pre-defined or user-defined. Examples of pre-defined business metrics are the cost or duration of an activity. An example of a user-defined business metric is the number of rejected orders in the order handling process computed by counting the number of order data documents whose status field was set to rejected upon completion of the process on a workday. User-defined business metrics are usually tightly coupled to data fields of data documents processed by a workflow instance that implements a business process model;

an ‘input slot’ refers to a type of business metric which serves as an interface for events issued by an instance of a business process;

a ‘location’ of a business metric is a specific state of execution of a workflow or of an activity within a workflow. For example, a metric can be evaluated upon start or end of a workflow or a specific activity. The available locations are determined by the underlying workflow engine and its capability to emit status information on the workflow execution;

a ‘condition’ specifies additional terms that indicate whether a metric is evaluated or not. Similar to a metric, a condition is formulated by referring to data document fields or workflow execution status messages;

a ‘constraint’ is a predicate defined on an observation model and covers a certain validity aspect of the observation model. The predicate needs to hold for each observation model instance in order for the observation model instances to satisfy the constraint. Where the predicate does not hold for each observation model instance, the observation model instances violate the constraint. A set of such constraints is required to explicitly define conditions for the validity of the observation model and guarantee the observation model's executability. Usually, an observation model may need to satisfy a set of approximately 60 constraints.

a ‘validation engine’ processes and maintains constraints and a given observation model. The validation engine produces a validation result which may then be provided to other components in a business monitoring engine;

an ‘execution engine’ is a computer program element which interprets the workflow described in an observation model and acts accordingly. Examples of an execution engine are business monitoring engines (which interpret observation models) and business process execution engines (which interpret process models).

In known business monitoring engines, a monitor is configured by a user filling in fields in an electronic form. Further, a monitor is configured with an observation model. A designer of an observation model may describe the observation model in various ways, although design errors in the observation model, which may lead to faulty execution of the observation model, may possibly not be noted and rectified by the designer. In particular, nondeterministic behaviour and infinite computation loops are the main errors in this context.

Known business monitoring engines offer a restrictive way to monitor a business process or workflow. A user would start by describing a business process graphically, which is then exported to a specific execution engine. Together with the business process model, a business measure could be defined consisting of a metric, a location, and a condition.

Business monitoring engines generally have a requirement to execute only valid business measures, and this validation may be limited through focusing on a limited number of possible observation model errors. Furthermore, conditions such as the acyclicity of metric definitions may not be completely ensured by a validation engine of the business monitoring engine. Thus, it may happen that non-computable observation models can be defined and sent to the business monitoring engine for execution.

There are two modes in which an observation model can be validated: online mode and offline mode. In online mode, the observation model is validated while the user is editing it, for example, when an attribute of an element is modified. In offline mode, the observation model is validated when the observation model is written to or read from a permanent storage device. For both modes, the time that a user has to wait for an observation model to be validated is preferably kept as short as possible.

An example of a constraint that an observation model needs to satisfy is now described; if the value of a metric is updated from two different maps in one execution path, only the most recently updated value of a metric will be available after the execution path is completed and therefore the previous updates of the value of a metric are useless. Alternatively, a map can have more than one input slot in the same execution path but the evaluation of these input slots takes place at different points in time. Consequently, a constraint is created which specifies that all metrics in each execution path should be updated by a maximum of one map. Therefore, this constraint restricts an observation model from having execution path configurations known as diamond metrics execution path configuration or race metrics execution path configuration.

Metrics can be aggregated to compute more complex business metrics. Initially, only the data fields of the particular workflow under consideration can be used. Thus, the metrics are tightly linked to the workflow model and the intended execution engine for the workflow. Furthermore, it is not possible to define a business metric that would allow a business monitoring engine to combine data across several workflows without coupling these workflows in an observation model. For example, order processing information and creditibility information can only be combined if the order document and the creditibility document are visible in the workflow for which the metric is defined.

Known business monitoring engines such as WBI Monitor and Modeler V6, which are commercial products of International Business Machines, Armonk N.Y., United States of America, have monitoring capabilities for business processes which are extended to meet the requirements of a service-oriented architecture. First, metrics are defined over arbitrary events received via a Common Event Infrastructure, CEI. This allows feeding of events of arbitrary structure and origin into the metric of a workflow and not only events caused by values of workflow-specific data or the status of the workflow engine. The arbitrary events can for example be issued by arbitrary instances of processes defined in the Business Process Execution Language BPEL, by Web services, or legacy workflow and application systems that have been integrated with the CEI. This mechanism enables the scope of monitoring to broaden beyond a specific workflow instance, decouple it from the underlying execution runtime and specific business processes and thus to monitor a service-oriented architecture in which the origins and structure of events can change flexibly during execution.

As a result, the definition of a business metric becomes more complex and requires, for example, the monitored elements to be additionally defined. A monitoring context is created in the monitor for each workflow instance of an observed entity, such as a business process, an activity or an application system, etc. The monitoring context is indexed by a set of key values that uniquely identify the instance, and it typically exists for the duration of the monitoring context's lifetime. Thus, a monitoring context may be thought of as an indexed container, which aggregates the business metrics describing the current state of a single, real-world entity. Monitoring contexts can be nested and business metrics can be made available within nested contexts. Business metrics and conditions can also be defined in a more general way and the evaluation of a business metric is no longer closely associated to a specific pre-defined location. A business metric will be evaluated whenever one of its input events occurs on the CEI and the value of the metric is updated accordingly. Business metrics that depend on other business metrics will always be re-evaluated when one of these other business metrics changes, ie. change is always propagated in an autonomous way.

Thus, a primary problem associated with known monitoring engines, is that design errors in the observation model lead to errors in the monitor and it is reliant upon the designer of the observation model to note such errors.

Another problem associated with known monitoring engines, is that complex operations on an observation model, for example, transformation or validation, involve numerous navigation operations. Such operations cost time, and the time needed for validating a large observation model can result in extended waiting times for the user, thus interrupting the user's workflow.

It is an aim of the present invention to provide a validation engine and method to mitigate the problems of the known art.

### SUMMARY OF THE INVENTION

According to a first aspect of the present invention there is provided a method for validating an observation model at a validation engine, the method comprising: receiving the observation model at a validation engine, identifying a constraint applicable to the observation model, classifying the applicable constraint, and validating the observation model dependent on the constraint category of the applicable constraint.

The step of classifying the applicable constraint may determine that the applicable constraint is a global uniqueness constraint or a global cyclic dependency constraint or alternatively, a local value restriction constraint, or alternatively, a local reference constraint or a local required entity constraint, or alternatively, a local uniqueness constraint or a local cyclic dependency constraint.

Preferably, the step of validating the observation model comprises executing a classification-based validation algorithm. Also, the validated observation model may be output from the validation engine to a monitoring engine. The term monitoring engine may refer to a business monitoring engine and may also be referred to as a monitor.

The step of receiving the observation model may comprise reading at least one model element from the observation model to the validation engine, and the step of identifying may comprise identifying a constraint applicable to the at least one model element, and the step of validating may comprise validating the at least one model element dependent on the constraint category of the applicable constraint. Further, the method may comprise a step of checking for further model elements to read from the observation model to the validation engine and, if at least one further element is present, then the next element is read from the observation model and the subsequent process steps are repeated. If no further elements are present then this operation is complete.

According to a second aspect of the present invention there is provided a validation engine for validating an observation model, the validation engine comprising: an observation model separator configured to receive the observation model and identify a constraint applicable to the observation model, and a validation algorithm processor configured to classify the applicable constraint and validate the observation model dependent on the constraint category of the applicable constraint.

The validation engine may further comprise; a data storage of constraints connected to the observation model separator, and a data storage of processed constraints connected to both the observation model separator and the validation algorithm processor. The validation algorithm processor may output the validated observation model from the validation engine to a data storage of validation results.

According to a third aspect of the present invention there is provided a computer program element comprising computer program code means which, when loaded in a processor of a data processing system, configures the processor to perform a method comprising the steps of: receiving the observation model at a validation engine, identifying a constraint applicable to the observation model, classifying the applicable constraint, and validating the observation model dependent on the constraint category of the applicable constraint.

### BRIEF DESCRIPTION OF THE FIGURES

Embodiments of the present invention will now be described, by way of examples only, with reference to the accompanying drawings in which:

FIG. 1 is a block diagram of a validation system in accordance with the present invention;

FIG. 2 illustrates interrelationships between identified classes of constraints;

FIG. 3 is a flowchart of the operations of an embodiment of the validation system;

FIG. 4 is a flowchart of the operations of the observation model separator;

FIG. 5 is a flowchart of the operations of the validation algorithm processor.

### DESCRIPTION OF PREFERRED EMBODIMENTS

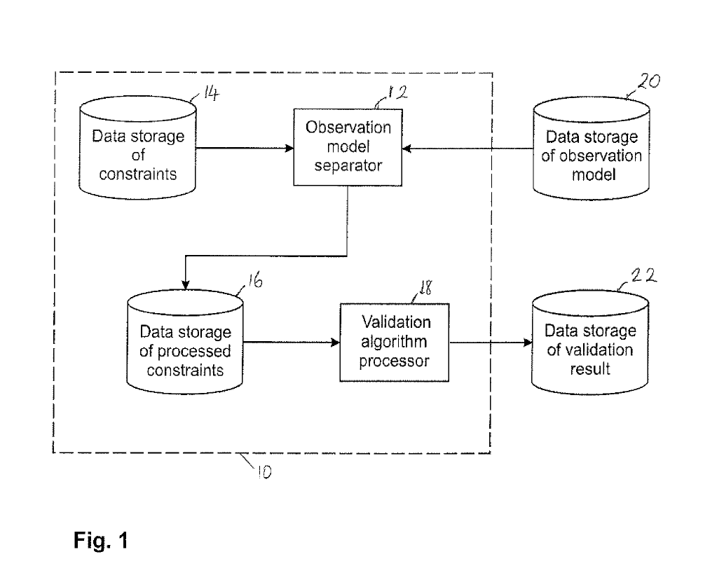

Referring first to FIG. 1, a validation engine 10 comprises an observation model separator 12, a data storage of constraints 14, a data storage of processed constraints 16 and a validation algorithm processor 18. The observation model separator 12 receives input from the data storage of constraints 14, the data storage of processed constraints 16 receives input from the observation model separator 12, and the validation algorithm processor 18 receives input from the data storage of processed constraints 16. A data storage of an observation model 20, and a data storage of a validation result 22 are each connected to the validation engine 10. Specifically, the data storage of an observation model 20 provides inputs to the observation model separator 12 and the data storage of a validation result 22 receives outputs from the validation algorithm processor 18.

In operation, the validation engine 10 processes and maintains the constraints and the given observation model. The validation engine 10 produces a validation result which may then be provided to other components in the business monitoring engine, such as an observation model editor. The data storage of constraints 14 holds permanent constraints and the data storage of processed constraints 16 holds temporary pairs of constraints and model elements.

Validation constraints can be considered to fall into one or more of several classes. These classes and their characteristics are set out below:

Local Constraints

A local constraint refers to a specific model element of the observation model and other model elements that can be reached from the specific model element. Two typical examples of local constraints are i) restrictions on the value of a model element's attribute, or ii) restrictions on the existence of other model elements that can be reached from the specific model element.

Global Constraints

A global constraint refers to several elements of one observation model that do not necessarily have to be tightly coupled through a navigation path. A typical example for a global constraint is the requirement that all elements in an observation model need to have distinct names.

All constraints may be classed by their locality and thus will fall into either the class of local constraints or the class of global constraints.

Graph Structure Constraints

These constraints delimit the structure of the graph that is defined by the elements of an observation model and the associations between those elements. This class divides into two subclasses:

Cyclic Dependency Constraints

Cyclic dependency constraints prohibit cyclic dependencies between elements in an observation model. An example of such a cyclic dependency follows herewith. Whilst it is syntactically allowed by a meta-model of the observation model for a map to use one of its input metrics as an output too, this would lead to an infinite loop of the business monitoring engine. This may not have been intended by the meta-model designer and may therefore lead to faulty observation models.

Reference Constraints

If an element refers to another element in the observation model, the referenced objects can be constrained in terms of type or structure. For example, a map in the observation model could be constrained to only have events as input metrics. Furthermore, the referenced object may be restricted to certain navigation paths or patterns. For example, the input metrics for a map are required to be in the same monitoring context as the map or in the parent context.

Uniqueness Constraints

It may be required that certain elements in an observation model have a key attribute which enables them to be distinguished from each other. This requirement is expressed as a uniqueness constraint. For example, it is required that the members of a namespace in UML2 are distinguishable from each other.

Value Restriction Constraints

In some cases it may be necessary to constrain the value of an attribute or the structure of the elements that are associated with another element. This class divides into two subclasses:

Data Type Constraints

Each element in a model can be considered to define a data type. Data types can be specialized where the specialized data type has an “is-a” relation with its supertype. For example, the data type “input slot” is a specialization of the data type “metric”. The data type of an element may be delimited to a certain set of data types, or an element may not be allowed to have a certain type. A type constraint can be used if the implementation of a system does not support all types that are defined in the system specification.

Literal Constraints

An attribute of an element may also be restricted by a literal value. Literal constraints can be used to refine the meta-model or adapting it to platform-specific requirements. For instance, the meta-model of the observation model allows a monitoring context to be the parent context of an arbitrary number of contexts. This arbitrary number could be constrained by indicating a literal value.

Required Entity Constraints

Required entity constraints demand the existence of other elements that an element depends on. A key metric is a special kind of metric which serves as a unique identifier for a monitoring context. Thus, an example from the observation model is that for each key metric map in a context relation there has to exist a key metric in the parent context.

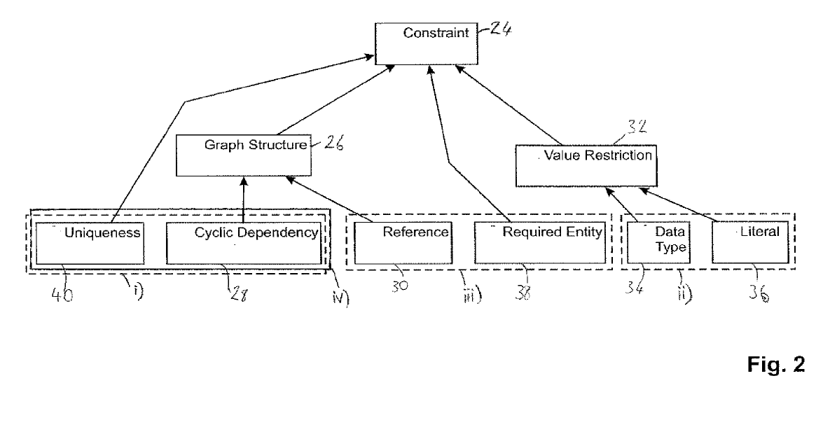

FIG. 2 illustrates the interrelationship of the above described classes of constraints 24. The class of graph structure constraints 26 is shown to subdivide into cyclic dependency constraints 28 and reference constraints 30. The class of value restriction constraints 32 is shown to subdivide into data type constraints 34 and literal constraints 36. Whereas required entity constraints 38 and uniqueness constraints 40 are not subdivided from a further class of constraints.

Four specific constraint categories are identified and are indicated on FIG. 2. Namely;
i) global uniqueness constraint or global cyclic dependency constraint
ii) local value restriction constraint
iii) local reference constraint or local required entity constraint
iv) local uniqueness constraint or local cyclic dependency constraint

This categorization of constraints is determined through exploiting characteristic constraint properties such as the locality and semantic nature of the condition formulated in a constraint. This categorization is performed in the validation algorithm processor 18 of the validation engine of FIG. 1.

It is noted that not all other potential categories of constraints are meaningful. For example, a global value restriction constraint would have no meaning because an observation model as a whole does not have a value. It is noted that global constraints are generally associated with an observation model and the global constraints consider a number of elements and the relationships between those elements. Whereas local constraints are associated with a single element and the neighbourhood of the single element.

When an observation model is determined by the validation engine 10 to fulfill the conditions defined by one of the four specific constraint categories i)-iv), then the observation model is executable. Thus, in such situations, the observation model is automatically validated, thereby avoiding the possibility of design errors in the observation model leading to undetected errors in the monitor.

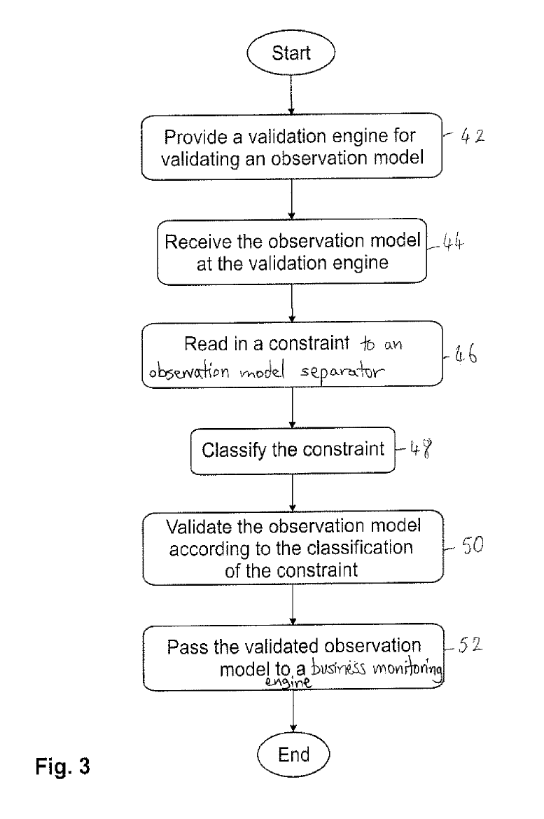

Turning to FIG. 3, a flowchart of the operations of an embodiment of the validation system is shown. A validation engine is provided 42 for validating an observation model. The observation model is a representation of the business metrics of a real-world system which is to be monitored. The observation model is received 44 at the validation engine and also a constraint is read 46 into an observation model separator in the validation engine. The next step in the operations is the classification 48 of the received constraint which takes place at the beginning of the validation algorithm processor. Then the observation model is validated 50 according to the classification of the constraint. Finally, the validated observation model is passed 52 to a business monitoring engine.

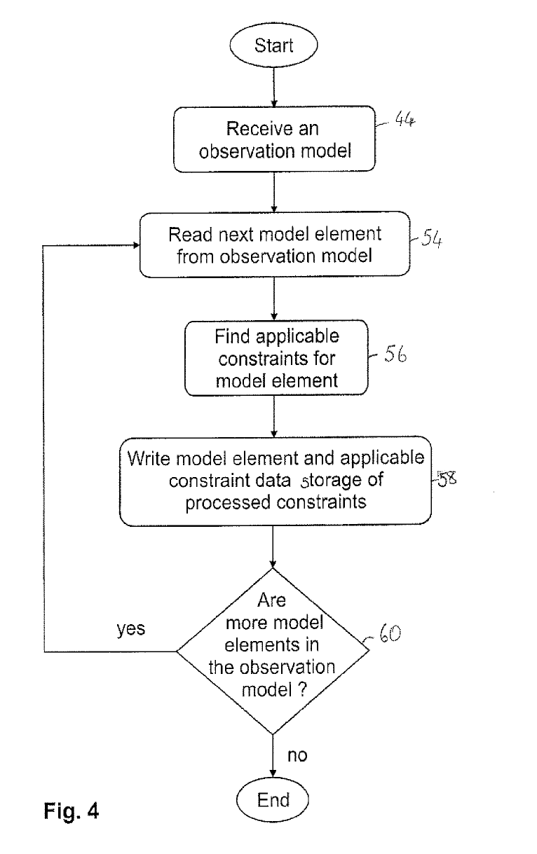

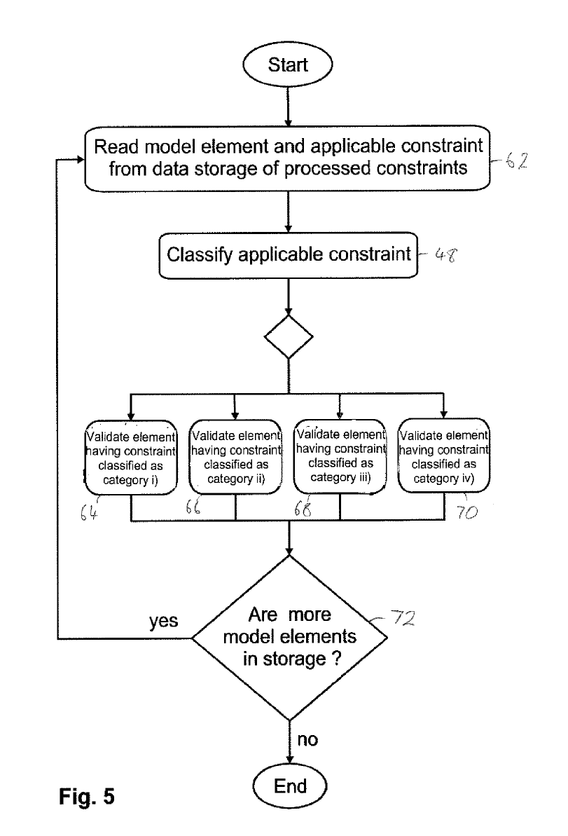

FIGS. 4 and 5 provide greater detail on some of the operations of FIG. 3. Therefore, reference numerals from FIG. 3 have been used in FIGS. 4 and 5 when indicating a common step.

In FIG. 4, a flowchart shows the operations of the observation model separator. In an initial step, the observation model separator receives 44 an observation model. Next, an element from the observation model is read 54 by the observation model separator. Applicable constraints for the element are found 56 through utilizing data input from the data storage of constraints in the validation engine. The element and applicable constraint are then written 58 to the data storage of processed constraints. The observation model separator then performs a check 60 for further elements in the observation model. If further elements are present, then the next element is read 54 from the observation model and the subsequent process steps 56 58 60 are repeated. If no further elements are present then the observation model separator operation is complete.

In FIG. 5 a flowchart of the operations of the validation algorithm processor is shown. In an initial step, the validation algorithm processor reads 62 an element and applicable constraint from the data storage of processed constraints. Next, the applicable constraint is classified 48 into one of the four specific constraint categories of the present invention which are identified and are indicated on FIG. 2. Namely;
i) global uniqueness constraint or global cyclic dependency constraint
ii) local value restriction constraint
iii) local reference constraint or local required entity constraint
iv) local uniqueness constraint or local cyclic dependency constraint

The model element is then validated 64, 66, 68, 70 according to the classification of the applicable constraint. The validation algorithm processor then performs a check 72 for further elements and applicable constraints in the data storage of processed constraints 16. If further elements and applicable constraint are present, then the next element and applicable constraint is read 62 from the data storage of processed constraints and the subsequent process steps 48, 64-70, 72 are repeated. If no further elements and applicable constraints are present then the validation algorithm processor operation is complete. The validated element or elements are output from the validation engine and written to a data storage of validation results 22.

Advantageously, the validation engine 10 enables the validation of an observation model at different points in time of an object lifecycle and thus the time that a user has to wait for an observation model to be validated is minimized. For example, as a result of the classification of applicable constraints, parts of an observation model can be validated when those parts are received at the validation engine, even though other parts of the observation model are still to be read, or ‘loaded’, from the data storage of observation model into the validation engine. Constraints from categories i), ii) and iv) may be validated on a single model element while it is loaded. This allows the validation of one model element after another during load-time. Constraints from category iii) are validated after the whole observation model has been loaded into the validation engine 10 because category iii) constraints require to navigate through the observation model.

Offline mode validation comprises user-triggered validation and validation when the observation model is persisted. Validation in online mode refers to validation that is triggered when a user edits a constrained model element. Advantageously, whether the validation engine is in online mode or offline mode, the time that a user has to wait for an observation model to be validated is minimized through the following optimizations.

The validation of constraints from category ii) benefits from the fact that there is no search procedure required in order to find model elements to which a category ii) constraint is applicable. This is valuable because a search procedure would require time consuming navigation operations. Instead, only a context element ie. a model element to which a constraint is applicable, is validated on so-called ‘edit-time’ or a context element is validated just once at the time when the observation model is loaded into the validation engine.

In order to determine the uniqueness of attribute values or the existence of cyclic dependencies there is a requirement to gather information from related model elements in the observation model. The classification-based validation engine 10 of the present invention avoids the need to have time consuming navigation operations which navigate through an observation model in order to find related model elements. Specifically, for constraint categories i) and iv), the validation engine provides storage of particular model elements for each applicable constraint. Further, information such as attribute values (for uniqueness constraints) or elements and their relations (for cyclic dependency constraints) can be derived from model elements in storage, rather than reading the information from the observation model as in known validation engines.

Further, advantage is also obtained in that violations of acyclicity can be detected efficiently by the validation engine of the present system.

In addition, a high degree of flexibility can be achieved for model validation. By optimizing both online mode and offline mode, an observation model designer can arbitrarily choose the appropriate validation mode. While online mode may be the most suitable in a majority of cases, offline mode can be chosen for large observation models for which the validation would result in an interruption of the user's workflow, even with optimized validation methods.

Whilst the above described system refers to observation models and their interpretation by business monitoring engines, it will be apparent to the skilled person that the system concepts may be applied to process models and their interpretation by business process execution engines.

In the above described system, the validation algorithm processor automatically categorizes a constraint using syntactic analysis. However, it is also possible that a constraint developer can manually pre-select a categorization of a constraint.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network or a wide area network, or the connection may be made to an external computer, for example, through the Internet using an Internet Service Provider.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Improvements and modifications can be made to the foregoing without departing from the scope of the present invention.

1. A method for validating an observation model, the method comprising:
receiving (44) the observation model at a validation engine,
identifying (56) a constraint applicable to the observation model,
classifying (48) the applicable constraint, and
validating (50) the observation model dependent on the constraint category of the applicable constraint.

2. The method as claimed in claim 1, wherein the step of classifying (48) the applicable constraint determines that the applicable constraint is a global uniqueness constraint or a global cyclic dependency constraint (i).

3. The method as claimed in claim 1, wherein the step of classifying (48) the applicable constraint determines that the applicable constraint is a local value restriction constraint (ii).

4. The method as claimed in claim 1, wherein the step of classifying (48) the applicable constraint determines that the applicable constraint is a local reference constraint or a local required entity constraint (iii).

5. The method as claimed in claim 1, wherein the step of classifying (48) the applicable constraint determines that the applicable constraint is a local uniqueness constraint or a local cyclic dependency constraint (iv).

6. The method as claimed in any of claims 1 to 5, wherein the step of validating (50) the observation model comprises executing a classification-based validation algorithm.

7. The method as claimed in claim 6, wherein the validated observation model is output from the validation engine (10) to a monitoring engine.

8. The method as claimed in claim 7, wherein the step of receiving (44) the observation model comprises reading at least one model element from the observation model to the validation engine, and the step of identifying comprises identifying a constraint applicable to the at least one model element, and the step of validating comprises validating the at least one model element dependent on the constraint category of the applicable constraint.

9. The method as claimed in claim 8, further comprising the step of checking (60) for further model elements to read from the observation model to the validation engine and, if at least one further element is present, performing the steps of claim 8.

10. A validation engine (10) for validating an observation model, the validation engine comprising:
an observation model separator (12) configured to receive the observation model and identify a constraint applicable to the observation model, and
a validation algorithm processor (18) configured to classify the applicable constraint and validate the observation model dependent on the constraint category of the applicable constraint.

11. The validation engine (10) as claimed in claim 10, wherein the validation algorithm processor (18) executes a classification-based validation algorithm to classify the applicable constraint as a global uniqueness constraint or a global cyclic dependency constraint (i).

12. The validation engine (10) as claimed in claim 10, wherein the validation algorithm processor (18) executes a classification-based validation algorithm to classify the applicable constraint as a local value restriction constraint (ii).

13. The validation engine (10) as claimed in claim 10, wherein the validation algorithm processor (18) executes a classification-based validation algorithm to classify the applicable constraint as a local reference constraint or a local required entity constraint (iii).

14. The validation engine (10) as claimed in claim 10, wherein the validation algorithm processor (18) executes a classification-based validation algorithm to classify the applicable constraint as a local uniqueness constraint or a local cyclic dependency constraint (iv).

15. The validation engine (10) as claimed in claims 10 to 14, the validation engine (10) further comprising;
a data storage of constraints (14) connected to the observation model separator (12), and
a data storage of processed constraints (16) connected to both the observation model separator (12) and the validation algorithm processor (18).

16. The validation engine (10) as claimed in claim 15, wherein the validation algorithm processor (18) outputs the validated observation model from the validation engine to a data storage of validation results (22).

17. A computer program element comprising computer program code means which, when loaded in a processor of a data processing system, configures the processor to perform a method comprising the steps of:
receiving (44) the observation model at a validation engine,
identifying (56) a constraint applicable to the observation model,
classifying (48) the applicable constraint, and
validating (50) the observation model dependent on the constraint category of the applicable constraint.

18. The computer program element as claimed in claim 17, wherein the method step of classifying (48) the applicable constraint determines that the applicable constraint is a global uniqueness constraint or a global cyclic dependency constraint (i).

19. The computer program element as claimed in claim 17, wherein the method step of classifying (48) the applicable constraint determines that the applicable constraint is a local value restriction constraint (ii).

20. The computer program element as claimed in claim 17, wherein the method step of classifying (48) the applicable constraint determines that the applicable constraint is a local reference constraint or a local required entity constraint (iii).

21. The computer program element as claimed in claim 17, wherein the method step of classifying (48) the applicable constraint determines that the applicable constraint is a local uniqueness constraint or a local cyclic dependency constraint (iv).

22. The computer program element as claimed in any of claims 17 to 21, wherein the method step of validating (50) the observation model comprises executing a classification-based validation algorithm.

23. The computer program element as claimed in claim 22, wherein the method step of receiving (44) the observation model comprises reading at least one model element from the observation model to the validation engine (10), and the step of identifying (56) comprises identifying a constraint applicable to the at least one model element, and the step of validating (50) comprises validating the at least one model element dependent on the constraint category of the applicable constraint.

24. The computer program element as claimed in claim 23, wherein the method further comprising the step of checking (60) for further model elements to read from the observation model to the validation engine (10) and, if at least one further element is present, performing the steps of claim 23.
